(19) United States
(12) Patent Application Publication
(10) Pub. No.: US 2006/0289250 A1
(43) Pub. Date: Dec. 28, 2006

(54) PIGMENTED NOISE INSULATOR FOR BRAKE PAD

(76) Inventors: Scott Dobrusky, Ypsilanti, MI (US); Steve Sehmer, Uniontown, OH (US); Ayaz A. Sheikh, Farmington Hills, MI (US); Patrick Hurley, Troy, MI (US)

Correspondence Address: WOOD, HERRON & EVANS, LLP, 2700 CAREW TOWER, 441 VINE STREET, CINCINNATI, OH, 45202, US

(21) Appl. No.: 11/423,239

(22) Filed: Jun. 9, 2006

Related U.S. Application Data
(60) Provisional application No. 60/691,142, filed on Jun. 16, 2005.

(51) Int. Cl. F16D 65/38

(52) U.S. Cl. 188/73.37

(57) ABSTRACT

A shim for a disc brake shoe incorporates a metal plate coated on both sides with an elastomer such as nitrile rubber. One elastomeric layer is coated with a pressure sensitive adhesive which facilitates attaching the shim to a brake pad. The other elastomeric layer is coated with a pigmented polyester or epoxy layer which is intended to match the color of the car.

Applicant claims the benefit of the priority date of U.S. provisional patent application Ser. No. 60/691,142 filed Jun. 16, 2005 which is herein expressly incorporated by reference for disclosure and background purposes. The following specification, claims and drawings supercede any inconsistency with said provisional patent application.

### BACKGROUND OF THE INVENTION

Brake pads incorporate a friction material designed to engage a disc or rotor; this friction material is molded to a steel back plate. A caliper assembly with a “fingers” side and a piston side presses against the back plate of brake pads (inner and outer), forcing the friction material against a rotor, thus initiating braking function of a vehicle. This interaction of disc brake assembly frequently causes vibration and/or squealing. To avoid this, sound damping “shims” are attached to the back plates of brake pads. The shims are generally metal substrates coated on one or both sides with a rubber and/or adhesive material designed to damp or absorb the noise vibrations.

With newer tire wheel designs, the back side of the outer brake pad-shim assembly can be visible through the hubs of the wheels. Until recently, the shims have been left in their natural color which is generally a blackish rubber material; occasionally expensive bare stainless steel shim covers are used to enhance the cosmetic appearance by covering shims. In addition to the visibility of the shim installed in a vehicle wheel system, aftermarket replacement friction marketers typically feature brake shims face up in the packaging (before it is installed). The color surface aspect allows these manufacturers to differentiate their product while in the packaging.

### SUMMARY OF THE INVENTION

The present invention is premised on the realization that the exposed side of brake shims can be esthetically improved while at the same time improving noise attenuating characteristics. The back side of the shim is coated with a pigmented polyester or epoxy material. More particularly, the brake shim is coated on both sides with an elastomeric coating such as nitrile rubber with the side opposite the brake pad coated with a pigmented viscoelastic polyester or epoxy material. In a preferred embodiment, the pigmented coating includes polytetrafloroethylene to further enhance performance characteristics. The coating tenaciously adheres to the surface of the shim and does not peel off or crack.

The objects and advantages of the present invention will be further appreciated in light of the following detailed description and drawings, in which:

### BRIEF DESCRIPTION OF THE DRAWINGS

FIG. 1 is a cross sectional view of the shim according to the present invention; and

FIG. 2 is a diagrammatic view of a brake assembly incorporating the shim of the present invention.

### DETAILED DESCRIPTION OF THE INVENTION

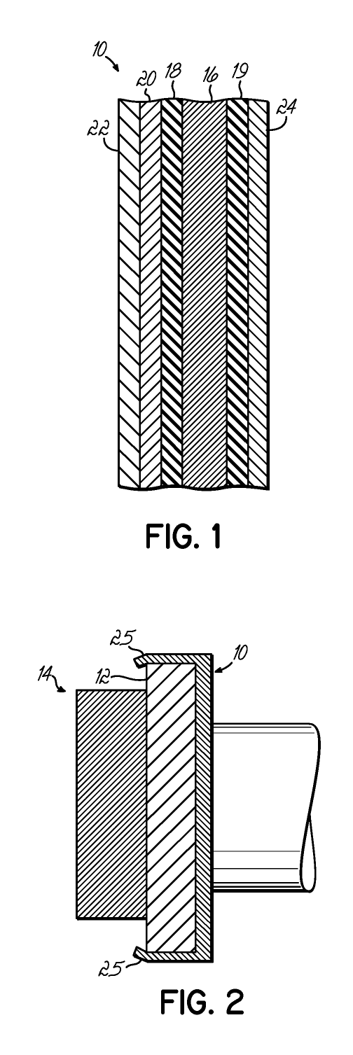

As shown in FIG. 1, the present invention is a shim 10 which is adapted to be attached to the back plate 12 of a brake pad 14. The shim 10 will include a central metal plate 16 coated on both sides with layers 18 and 19 of a sound absorbing elastomeric material, such as NBR rubber. Sound absorbing layer 18 is preferably coated with a pressure sensitive adhesive layer 20 which is covered with a release sheet 22. Sound absorbing layer 19 is coated with a pigmented coating layer 24. The shim, as shown, includes optional clips 25 to assist in attaching the shim to a brake pad.

The shim 10 is applied to the back plate 12 of a brake pad 14 by removing the release paper 22 and adhering it to the back side of the back plate 12 using the pressure sensitive adhesive layer 20. If no pressure sensitive adhesive layer is used, the clips 25 will hold the shim 10 to the brake pad 14. This assembly is then installed into a brake assembly with the piston or the caliper of the brake assembly engaging the colored surface 24 of the shim 10 which is adhered to the back plate 12 of the brake pad 14.

Any pigmented coating that will adhere to the elastomeric layer 19 can be used in the present invention. Preferably, this coating will be a polyester or epoxy. A coating that includes a fluorinated hydrocarbon polymer such as polytetrafluoroethylene is preferred for shims that include clips. The added PTFE enhances the forming characteristics of the shim.

The pigmented coating layer 24 should be as thick as required to achieve the desired aesthetic affect. Generally, layer 24 will have a thickness not exceeding 0.005 mm. The pigments employed in the exterior coatings 24 in some cases are selected to match the exterior color of the car. Accordingly, if a car is red, a red pigmented outer coating is used on the shim. Thus, the colored, coated shim will blend in with the color of the car, providing improved aesthetics.

The metal layer 16 can be any metal commonly used in brake shims, including cold rolled steel, hot dipped galvanized steel, stainless steel and aluminum. The thickness of layer 16 is determined by application requirements, and can vary from about 0.4 mm to about 0.8 mm, although the precise thickness, again, is a function of end use requirements.

The elastomeric coating layers 18 and 19 on shim 10 can be any vibration absorbing elastomer suitable for automotive applications. The preferred elastomer is nitrile polymer and its thickness can range from 0.05 mm to about 0.12 mm for each layer. A wide variety of thickness and rubber formulations can be used in order to meet end use requirements.

The shim of the present invention is formed using standard coating methods. Typically, a roll coater preferably a reverse roll coater, is used to apply the coatings on shim 10. The shims are formed from a roll of sheet metal. The surfaces of the metal sheet are mechanically cleaned and dried. An acid or alkaline cleaning can be used, or a combination of the two.

The sheet metal is pulled through a line for pre-treatment. One or both sides of the metal can be pre-treated. Generally, a chromium or titanium base pre-treatment is applied. The pre-treated metal is then dried and a primer is applied to both surfaces. For nitrile rubber coated shims, a nitrile phenolic primer is preferred.

The pre-treated metal primed on both sides is coated with an elastomeric layer 18, which is then run through an oven and cured. The opposite side of the metal 16 is then coated with a second elastomeric layer 19, and cured. The pigmented coating layer 24 is applied over layer 19, and the coated metal is run through an oven, and cured. The pressure sensitive adhesive layer 20 is applied to the layer 18 and is covered with release sheet 22. The shims 10, are stamped from the formed laminate.

Clips 25 are bent to the desired shape. The PTFE loaded coating layer 24 reduces the coefficient of friction which facilitates formation of the clips.

Once applied to a brake shoe, as shown in FIG. 2, the brake shims 10 provide an effective noise dampening while at the same time providing an improved appearance. The added elastomeric layer 19 improves the vibration absorption of the shims.

This has been a description of the present invention along with the preferred method of practicing the present invention. However, the invention itself should only be defined by the appended claims,

Wherein we claim:

1. A brake shim comprising:
a central metal layer having first and second sides;
first and second elastomeric layers adhered to said first and second sides respectively; and
an outer pigmented layer adhered to said second elastomeric layer.

2. The brake shim claimed in claim 1 wherein said pigmented layer is a polyester layer.

3. The method claimed in claim 1 wherein said pigmented layer includes polytetrafloroethylene.

4. The brake shim claimed in claim 1 further comprising a pressure sensitive adhesive layer covered with a release sheet on said first elastomeric layer.

5. The shim claimed in claim 1 wherein said metal layer has a thickness of 0.4 mm to about 0.8 mm.

6. The shim claimed in claim 1 wherein said elastomeric layers have a thickness of about 0.05 mm to about 0.12 mm each.

7. The shim claimed in claim 3 wherein said pigmented layer is one of a polyester and an epoxy.

8. The shim claimed in claim 1 wherein said elastomeric layers are nitrile rubber.

9. The shim claimed in claim 1 wherein said elastomeric layers are acrylic rubber.

10. The shim claimed in claim 3 further including a plurality of clips.
